(19) United States
(12) Patent Application Publication
(10) Pub. No.: US 2025/0091139 A1
(43) Pub. Date: Mar. 20, 2025

(54) HAND-HELD MACHINE FOR REMOVING A FRICTION-WELDED ELEMENT FROM A COMPONENT ASSEMBLY

(71) Applicant: EJOT SE & Co. KG, Bad Berleburg (DE)

(72) Inventors: Marco WERKMEISTER, Leinatal / Schoenau v.d.W (DE); Toni MUELLER, Gotha (DE)

(73) Assignee: EJOT SE & Co. KG, Bad Berleburg (DE)

(21) Appl. No.: 18/562,281

(22) PCT Filed: May 18, 2022
(86) PCT No.: PCT/EP2022/063480

§ 371 Date: Nov. 17, 2023

(30) Foreign Application Priority Data
May 18, 2021 (DE) 10 2021 112 905.2

(51) Int. Cl. B23B 47/28; B23B 49/00

(52) U.S. Cl. CPC B23B 47/284; B23B 49/006

(57) ABSTRACT

The invention relates to a hand-held machine (10) for removing a friction-welded element, having a head, from a component assembly, wherein the hand-held machine (10) comprises a machine housing (12) and a drive unit (14) which is received therein, wherein, furthermore, an attachment device (20) is provided which is connected to the machine housing, wherein the attachment device comprises, furthermore, a telescopic element (22) which has a first component (24), arranged free from movement relative to the machine housing, and a second component (26), arranged movably in the axial direction relative to the first component, wherein the second component is prestressed in the axial direction in the pressing direction against the machine housing; furthermore, the attachment device has a tool drive shaft (30) which is driven via the drive unit, wherein the tool drive shaft is mounted rotationally on the second component by a bearing element (38).

This patent application is the national phase entry of PCT/EP2022/063480, international application filing date May 18, 2022, which claims the benefit and priority of and to German patent application no. 10 2021 112 905.2, filed May 18, 2021.

PCT/EP2022/063480, international application filing date May 18, 2022 and German patent application no. 10 2021 112 905.2, filed May 18, 2021 are incorporated herein by reference hereto in their entireties.

### BACKGROUND OF THE INVENTION

The invention relates to a hand-held machine for removing a friction-welded element from a component assembly.

The joining process of friction welding with a friction-welded element is also employed in composite design, as used for example in automotive engineering. In this process, a top layer of a softer material is routinely joined to an underlying base layer of a harder material in such a way that an auxiliary joining partner, i.e. the friction-welded element, which has a head and a shank, forms a welded joint with the base layer after it has penetrated the top layer, by heat generation as a result of rotation under contact pressure. The head of the friction-welded element routinely holds the top layer in a positive fit. Both the base layer and the friction-welded elements are routinely made of steel, with the top layer often being aluminum or a fiber composite material.

Since this joining process produces a material bond between the friction-welded element and the base layer, which usually consists of a thin sheet metal, it is difficult both to disconnect such a bond manually and to reconnect the layers using a friction-welded element. Another reason for this is that the joints to be machined are individual and often difficult to access.

It should therefore be made possible to machine the joints using a hand-held machine. What is desired for this purpose is the straightest possible guidance of the hand-held machine.

Various concepts ranging from mechanical to optical to acoustic are known for the straight guidance of hand-held machines, especially hand drills.

A mechanical alignment aid for a hand drill for drilling dowel holes is known from AT 375 292 B, for example. This device includes a first stationary element on which an outer sleeve is telescopically guided. The outer sleeve is spring-loaded against the receiving element via which the device is attached to the drill. A similar alignment and guidance aid is known from DE 2 451 292 B2.

DE 10 2017 128 892 A1 discloses an adapter, in which the tool is mounted on a machine-side part of the adapter, with the tool being received in a chuck. A workpiece-side part is spring-loaded against the machine-side part.

Optical detection of the alignment of the drill with respect to a workpiece is disclosed in DE 34 05 498 A1. In this case, a light plummet is used, which is aligned with the aid of a vial bubble.

DE 43 36 730 A1 discloses a drill, the alignment of which is also determined via reflection measurement. The alignment can be detected using light beams or ultrasound.

U.S. Pat. No. 4,078,869 A discloses a laser alignment aid in which the alignment can be adjusted by changing the pattern on the surface.

However, these designs are not suitable for removing a friction-welded element made of steel from a component assembly in a process-safe manner.

### SUMMARY OF THE INVENTION

It is the object of the invention to provide a hand-held machine for removing a friction-welded element made of steel from such a component assembly in a process-safe manner, allowing in particular reconnection of the assembly by means of a friction-welded element, as well as a method therefor.

This object is accomplished for the device by the features of claim 1 and for the method by the features of claim 12.

The dependent claims relate to advantageous further embodiments of the invention.

The invention is based on the realization that the positive retention of the top layer by the head of the friction-welded element can be released by making a hole into the head, which hole is slightly larger in diameter than the shank. It is then possible to reconnect the assembly using a friction-welded element. by removing the shank up to approximately the end of the heat-affected zone of the friction-welded element used, without penetrating the base layer.

The invention relates to a hand-held machine for removing a friction-welded element from a component assembly, which composite assembly has a top layer, a base layer, and a friction-welded element connected to the base layer by a material bond, with the top layer being held in place in a form-fitting manner by the head of the friction-welded element.

The hand-held machine includes a machine housing and a drive unit received in the machine housing, wherein the drive unit is connected to and rotates a machining tool. The machine housing has a handle which is used to operate the machine.

The drive unit preferably comprises a drive motor, a gearbox, if necessary, and a drive shaft driven by the drive motor.

A machining tool, which is in particular a drill or a milling cutter, can be connected indirectly or directly via the drive shaft, with the machining tool being made to rotate by the drive shaft of the drive unit via a tool drive shaft.

An attachment device is connected to the machine housing. The attachment device comprises a telescopic element having a first component arranged free from movement relative to the machine housing, and a second component, arranged movably in the axial direction relative to the first component. The second component is prestressed in the axial direction in the pressing direction against the drive housing by a spring arrangement.

The second component includes a telescopic guide portion via which the second component is in engagement with the first component. The telescopic guide portion is designed in particular in such a way that the second component is guided in a torsion-proof manner with respect to the first component and preferably in such a way that there is a pull-out limit between the first component and the second component, against which the second component is pressed under the spring prestress of the spring arrangement.

The machine housing and the second component can thus only be moved towards one another by overcoming the spring force. This ensures improved guidance of the hand-held machine in the axial direction during operation.

At its front end, the second component also has a contact element, the front end of which is to be used to place the hand-held machine on a component assembly.

In addition, a stop is provided which acts between the second component and the drive housing, and which is used to limit the drilling depth. The stop has a stop surface on the machine housing side and a stop surface on the contact element side. The stop can thus act indirectly or directly between the second component and the machine housing in order to set the maximum drilling depth.

The machining tool can be guided from its starting position, when the second component is in contact with the pull out limit, over a travel distance up to the stop, when the maximum drilling depth is reached. In this process, the tool penetrates the head and machines the friction-welded element to the maximum drilling depth. The path from the top of the head to the maximum drilling depth is the drilling path. The drilling depth is preferably between about 0.5 mm and 0.8 mm below the surface of the bottom component, the base layer.

The travel distance is preferably chosen to be longer than, or equal to, the drilling path. This ensures that, in the initial position, with the contact element in place, the distance from the tip to the head is greater than the distance of the head surface of the friction-welded element to be removed from the surface of the top component, a top layer, thus allowing the contact surface to be reliably placed on the top component layer.

The position of the starting point relative to the contact surface can be adjusted by means of contact elements of different lengths or by a position-variable pull-out limit. This makes it possible to adjust it to different head heights.

Furthermore, the attachment device has a tool drive shaft which is driven via the drive unit, with the tool drive shaft being rotationally mounted relative to the second component, which is coaxial with the tool drive shaft, by a bearing element. The tool drive shaft can be detachably connected to a drive shaft of the drive unit or be integral with the latter.

The invention provides for the bearing element to be located between the telescopic guide portion and the front end of the contact element. The bearing element is preferably designed as a sliding bearing. This is a simple way of achieving a bearing in the speed range of the tool drive shaft of around 4,000 rpm, and ensures axial guidance.

In this way, the bearing element for supporting the tool drive shaft carrying the machining tool is located at a defined distance from the component assembly over the entire machining process, preferably in the front area of the second component.

This makes for very precise centering and guidance of the machining tool during placement, thus resulting in a largely slip-free penetration into the head of the friction-welded element, which is made in particular of a hard material, even when the tool is guided manually. After this initial penetration, further axial feed can be made against the spring prestress, making for more reliable machining along the centerline of the friction-welded element.

The distance from the front of the contact element to the bearing element is preferably between 2.5 and 3.5 times the outside diameter of the machining tool. This ensures that the machining tool is guided as “wobble-free” as possible over as large a portion of the maximum drilling depth as possible.

The bearing element preferably extends over a length of at least three times the outer diameter of the machining tool. This makes for good guiding characteristics.

The outer diameter of the tool drive shaft, at least in the guide area, is greater than or equal to, preferably slightly greater than, the outer diameter of the machining tool. This allows for a drilling depth that is greater than the distance between the contact surface and the bearing element, which in turn enables the tool to be guided as closely as possible to the contact surface or above the contact surface.

The material of the bearing element is preferably made of a non-ferrous metal, for example brass or sintered bronze. Graphite-based solid lubrication may also be provided.

The contact element is preferably sleeve-shaped and has lateral recesses. Preferably, the wall thickness of the contact element in the area between the contact surface and the bearing element is at least partially less than the distance between the inner diameter of the recess and the outer diameter of the contact element. This results in an increase in the space at the penetration point, which can improve chip evacuation from the penetration point.

In an advantageous embodiment of the invention, the contact element can be designed to be detachable from the other parts of the second component, thus allowing the tool to be adapted in a simple manner to the head shape and the head dimension of the friction-welded element to be removed, by selecting different contact elements.

The material of the contact element is preferably a non-ferrous metal or steel. This will prevent drilling chips from being pressed into the contact surface of the contact element. This more reliably ensures even placement of the hand-held machine.

It is also conceivable for the bearing element and the contact element to form a one-piece assembly of the second component.

The contact element has an opening at its front end through which the machining tool can be passed and which is larger than the head of the friction-welded element to be machined, so that the contact element can be placed next to the head on the top layer of the component assembly.

The cross-sectional shape of the opening preferably corresponds to the cross-sectional shape of the head of the friction-welded element to be removed, and is only slightly larger in its extent.

In particular, the cross-sectional shape of the opening can be a circle, the diameter of which is the inner diameter of the contact element.

Preferably, the contact element has a scraper starting from the opening in the direction of the machine housing. The scraper is designed such that the machining tool can penetrate the scraper completely. but the head, or the drilled-off remainder of the head, is prevented from passing the scraper.

This allows the fastener head, or remnants of the fastener head, to be scraped from the machining tool during the retracting motion of the machining tool. This is especially true if the machining tool has a twist geometry.

Preferably, the lateral recesses of the contact element are located between the opening and the scraper. This ensures that the scraper will not obstruct chip evacuation from the drilling point to the side recesses.

This is particularly advantageous if the scraper is designed as an area with a recess which is smaller in diameter than the diameter of the opening in the contact element.

Furthermore, a scraper can also be integrated close to the contact surface in such a way that it forms the counterpart to the head geometry and is directly adjacent to it when the contact surface is in place. The inner diameter is slightly larger than the outer diameter of the tool drive shaft but smaller than the diameter of the opening in the contact surface and thus smaller than the outer diameter of the head of the friction-welded element to be removed.

The inner diameter of the opening of the contact element at its contact surface preferably corresponds to a factor x multiplied by the outer diameter of the machining tool, where 1.75<=x<=2.25.

This is a common ratio of the head outer diameter to the shank diameter.

Accordingly, the inner diameter of the opening is selected so that it rests on the head of the friction-welded element with as little play as possible around its circumference. This makes it more difficult for the attachment device to tilt relative to the head, and facilitates coaxial alignment of the central axis of the machining tool with the central axis of the fastener.

The precise alignment of the contact element with respect to the head and the small distance between the bearing element and the contact surface allow precise guidance of the machining tool on the friction-welded element, thus enabling centered, reliable tapping of the head, which can be made of a hard material, so that a centered coaxial placement is reliably possible, so that the shank of the friction-welded element can be drilled out completely with a machining tool having a diameter which is only slightly larger than the outer diameter of the shank. In this way, an appropriate element can be welded into the resulting blind hole.

The outer diameter of the contact element is preferably between 3.5 and 4.5 times the outer diameter of the machining tool. This makes for improved placement of the contact element on a component in a tight installation situation.

Furthermore, especially when the contact surface of the contact element is small, with an outer diameter of between 3.5 and 4.5 times the outer diameter of the machining tool, the attachment device can preferably have an alignment aid, which alignment aid is designed in such a way that it allows detection of at least one deviation from a working position.

The alignment aid may include at least one accelerometer capable of detecting and displaying a deviation from a working position. In particular, the at least one accelerometer detects acceleration about at least two axes.

Preferably, the current position is initialized as the working position after the contact element has been placed on the component and the working direction has been set. The tool can be aligned without having to apply a force in the working direction for machining. This makes for a relatively accurate initial alignment. Deviation from the working direction can be shown by an electro-optical display, for example an LED ring around the attachment device, which ring lights up at the point that is in the direction in which there is a deviation.

In another preferred embodiment of the invention, the alignment aid may comprise an optical projection device that projects a pattern onto the component assembly. The projection direction is chosen so that the pattern reveals an orthogonal position of the working direction with respect to the surface onto which the pattern is projected. This can be achieved in particular by a line pattern having a dot pattern superimposed on it. This allows the pattern to be monitored for its alignment also during the removal process so that the working position can be maintained.

Preferably, the pattern includes two lines that intersect in their extension on the central axis of the drive shaft, and two points created at an angle of 45° with respect to the central axis, so that one of each of the two points will be on one of each of the two lines when the shaft is normal to the contact plane.

Advantageously, the alignment aid comprising an optical projection device is arranged on the second component. This means that the projection device is mounted at a fixed distance from the contact plane, so that the pattern in the contact plane will not change depending on the current drilling depth.

During the machining operation, in which considerable force must be applied depending on the hardness of the fastener, a display device then displays a deviation from the working position, in particular also the change in direction of the inclination, in order to facilitate guidance of the hand-held machine in the working position along the working direction.

The attachment device preferably has a connection area with which the attachment device can be connected to the machine housing in a detachable and twist-proof manner.

The stop for setting the drilling depth can be equipped with a signal unit that will output a signal when the stop has been reached.

This will reduce heat input into the component assembly, because it allows the machining process to be stopped immediately when the preset drilling depth has been reached.

The fact that a signal is additionally issued when the stop has been reached is advantageous because the pressure force necessary to remove the fastener is so great that a user may not necessarily feel it when the tool has reached the stop, causing the machining tool to rotate unnecessarily long in the component assembly.

The signal unit may be in the form of an electro-optical and/or electro-acoustic signal unit.

In a simple form, the electro-optical signal unit can comprise a light source, in particular an LED.

The stop can have an electric switch, in particular a so-called pushbutton, which will be actuated when the drilling depth has been reached. Pressing the pushbutton can then trigger an electronic display signal so that the user can actually see that the preset drilling depth has now been reached.

In another advantageous embodiment of the invention, the stop may comprise a timer that will output a time-delayed signal after the stop has been detected.

The electro-optical display unit may have its own power supply or be connected to the power supply of the drive unit.

Preferably, the stop point of the stop is adapted to be adjusted in such a way that the drilling depth can be varied. For this purpose, the position of the stop surface on the machine housing side and/or the position of the stop surface on the contact element side can be made to be adjustable in their distance from each other.

In a preferred embodiment of the invention, the stop has at least one adjusting element that serves to change the position of the machine housing-side stop surface and/or the position of the contact element-side stop surface.

The adjusting element is preferably designed to be suitable for adjusting the stop surface on the contact element side.

As a result, the adjusting element is moved by the moving part against the first component, which is connected to the machine housing free from movement relative thereto. This means that a pushbutton which responds to contact or approach of the adjusting element can be accommodated free from movement relative to the machine housing. This facilitates integration into the circuit for controlling the electro-optical display.

The adjusting element may comprise a rod that can be displaced in its positioning and can be fixed in a selected position.

The adjusting element can be a threaded sleeve, preferably arranged on the second component, and adapted to be rotatable about the rotational axis of the tool shaft. Rotation thus changes the axial position of the adjusting element.

More preferably, the adjusting element is fine-adjustable. For this purpose, the adjusting element can preferably have a fine-pitch thread.

The machining tool is a drill or a milling cutter. A drill preferably has a tip angle of 140°+/−5°.

This angle promotes high-quality connection of the friction-welded element to the base layer. This creates a face-to-face connection over an area that is the same size as that of the original frictional joint connection. This allows an equally robust joint to be created. As a result, a friction-welded element that corresponds in type and length to the friction-welded element originally used can also be used for repair welding. This is particularly important if defects are detected in an inspection of joints during manufacture. As a result, the joints can then be produced again immediately with the same joining device.

In an advantageous development of the invention, the first component can be guided radially outside the second component. This has the advantage that the second component can be designed with a smaller diameter and that a spring can be arranged within the telescopic element.

In another advantageous embodiment of the invention, the second component can also be arranged radially outside a radially inner first component, with the prestressing spring arrangement preferably being a pressure spring that is located radially outside the first component and is designed as a helical spring.

In another advantageous embodiment of the invention, the attachment device may be detachably connected to the machine housing. This means that the attachment device can also be used as a retrofit to convert a commercially available drill or the like into a hand-held machine according to the invention for removing a friction-welded element from a composite assembly.

In the case of a detachable arrangement, the spring is preferably supported between the first component and the second component, with the subsequent relatively motion-free connection of the first component to the machine housing also prestressing the second component against the machine housing.

In particular, with the detachable attachment device, the tool shank can then be detachably connected to an output shaft of the machining tool, for example via a drill chuck. In addition, a connecting device may be provided to allow the first component of the attachment device to be connected to the machine housing without relative movement. Some of the commercially available drills already have connection options for various attachments devices, so that a commercially available drill or a cordless drill can constitute the drive unit with the machine housing for a hand-held machine according to the invention.

The means for mounting the attachment device on the housing can also be provided in the form of a clamp.

In another aspect thereof, the invention relates to a method of repairing a component assembly comprising a friction-welded member having a head and a shank, with the head having a head diameter and the shank having a shank diameter. The friction-welded element positively connects a top layer through its head to a base layer, to which the friction-welded element is materially bonded in a welded joint.

The method of the invention provides for using a hand-held machine comprising a machining tool for removing the shank of the friction-welded element by passing the rotating machining tool through the head of the friction-welded element in the direction of the shank until a blind hole has been drilled to a depth at which the friction welding zone of the friction-welded element with the base layer is located. wherein the outer diameter of the machining tool is at least equal to the outer diameter of the shank of the fastener, which allows a new friction-welded element to be inserted after completion of the drilling process, that then forms a friction-welded joint with the bottom of the blind hole.

In an advantageous manner, a hand-held machine as described above is used to remove the friction-welded element from the component assembly.

The hand-held machine used preferably has a contact element, in which the cross-sectional shape of the recess of the contact element corresponds to the cross-sectional shape of the head, and the extent of the recess is only slightly greater than the extent of the head of the friction-welded element.

This allows the machining tool to be positioned in an ideally centered manner on the head of the friction-welded element.

In a further preferred embodiment, the hand-held machine has a machining tool which is designed as a drill and which has a tip angle that corresponds to the tip angle of the friction-welded element to be used subsequently.

The friction-welded element subsequently used for the removal process can be produced either with a hand-held setting device or with an automatic setting machine.

As a result, if a friction-welded element is removed manually from a joint, for example from a joint that was already determined to be faulty during production, this joint can then be produced again by an automatic friction welding machine.

For removing a friction-welded element from its initial position, when the second component rests against the pull-out limit, the machining tool is hand-guided over a travel distance up to the stop, when the maximum drilling depth has been reached.

The head is penetrated and the friction-welded element is drilled out to the maximum drilling depth. The maximum drilling depth is in the area of the welding zone of the friction-welded element. This is routinely between about 0.5 mm and 0.8 mm below the surface of the base layer which faces the top layer.

This allows a friction-welded element, which corresponds in type and length to the friction-welded element originally used in the manufacture of the joint, to also be used for repair welding.

In particular, the travel distance is selected so that, in the initial position with the contact element in place, the distance between the tip and the head is greater than the distance between the head surface of the friction-welded element to be removed and the surface of the top component. This allows the contact surface to be reliably placed on the top component.

Additional advantages, features and possible applications of the present invention will be apparent from the description which follows, in which reference is made to the embodiments illustrated in the drawings.

### BRIEF DESCRIPTION OF THE DRAWINGS

In the drawings,

FIG. 1 is a schematic sectional view of a hand-held machine according to the invention, before its placement;

FIG. 2 is a schematic sectional view of a hand-held machine according to the invention, during placement;

FIG. 3 is a schematic sectional view of a hand-held machine according to the invention, when the adjusted drilling depth has been reached;

FIG. 4 is a schematic sectional view of a hand-held machine according to the invention, when there is a deviation from the working orientation;

FIG. 5 is a schematic sectional view of another embodiment of a hand-held machine according to the invention, during placement;

FIG. 6a is a pattern generated by the alignment aid of the embodiment shown in FIG. 5, when there is orthogonality:

FIG. 6b is a pattern generated by the alignment aid of the embodiment of FIG. 5 when there is an inclination; and

FIG. 7 is another embodiment of a hand-held machine according to the invention.

### DESCRIPTION OF THE INVENTION

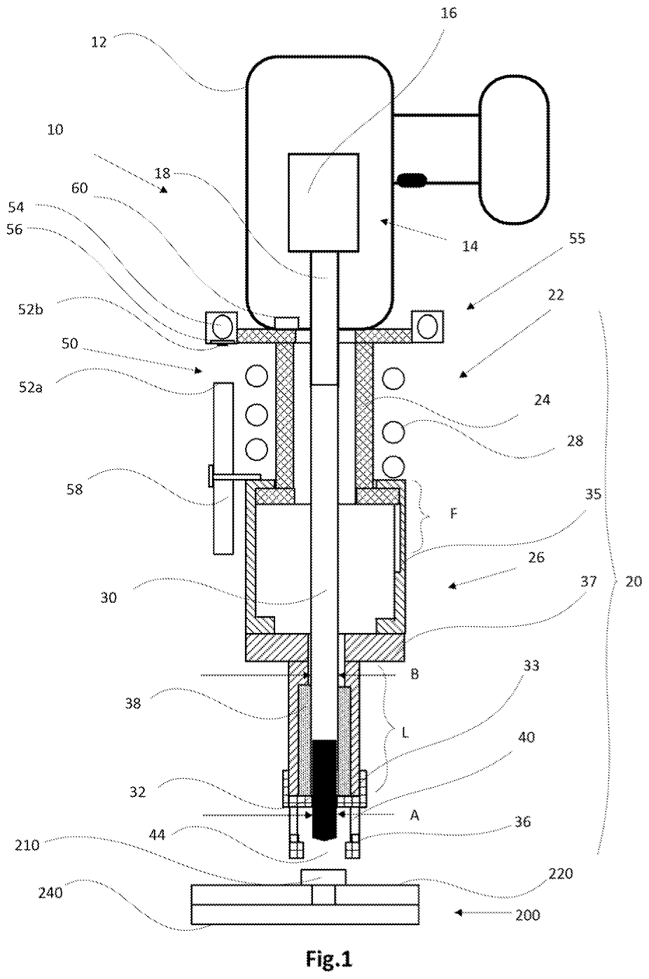

FIG. 1 is a schematic sectional view of a hand-held machine 10 according to the invention for removing a friction-welded element 210 from a component assembly 200. The component assembly 200 comprises a top layer 220 and a base layer 240 joined by the friction-welded element 210. The friction-welded element 210 is materially bonded to the base layer 240 via a welding zone 230, and holds the top layer 220 positively against the base layer 240.

To this end, the hand-held machine 10 includes a machine housing 12 and a drive unit 14 received therein, which in turn includes a drive motor 16 and a drive shaft 18.

The hand-held machine 10 further includes an attachment device 20 connected to the machine housing 12, which attachment device 20 includes a telescopic element 22, which telescopic element 22 in turn includes a first component 24 arranged free from movement relative to the machine housing 12, and a second component 26 arranged so as to be movable in the axial direction relative to the first component 24.

A coil spring 28 is disposed between the first component 24 and the second component 26, which prestresses the second component 26 relative to the machine housing 12. The second component 26 is penetrated by a tool drive shaft 30 which carries a machining tool 32, in this case a drill, at its forward end.

The tool drive shaft 30 is coaxial with the telescopic element 22.

The second component 26 includes a guide sleeve 35 which is in non-rotational engagement with the first component 24 via a guide region F, a pressure piece 37 which is connected to the guide sleeve 35 and in which a bearing element 38 is received in which the tool drive shaft 30 is slidably mounted. The pressure piece 37 may be made of steel, and the inserted bearing element 38 may be made of brass. Alternatively, the entire pressure piece 37 may form the sliding bearing and may accordingly be formed entirely of a single material, such as brass.

The second component 26 then terminates in a contact element 36. the front end of which is placed on the top layer 220 of the component assembly 200. The contact element 36 is preferably placed on the pressure piece 37.

The bearing element 38 starts from the front end, near the front end of the contact element 36. In this case, the distance of the bearing element 38 from the front end of the contact element is preferably smaller than three times the outer diameter A of the machining tool 32.

The contact element 36 has a scraper 33. The scraper 33 is formed integrally with the rest of the contact element 36. Thus, a boundary surface is formed between the region of the contact element 36 having the recesses 40 and the bearing element 38, in which an opening is made that is slightly larger than the outer diameter B of the tool drive shaft 30.

As a result, the machining tool 32 can pass the scraper 33. The head, or parts of the head, are scraped from the machining tool 32, in particular from the twist geometry of the machining tool 32, at the scraper 33 after the drilling process or even during the drilling process.

The bearing element 38 supports the tool drive shaft 30 over a bearing length L. This bearing length L is greater than three times the outer diameter A of the machining tool, which makes it possible to obtain stable guidance over a large range, in particular the entire range, of the drilling depth. On its side or on its circumference, the contact element 36 has recesses 40 which are used for discharging the chips removed during the drilling operation.

The outer diameter A of the machining tool 32 is smaller than the outer diameter B of the tool drive shaft 30. This allows the tool drive shaft 30 to be rotatably supported in the sliding bearing sleeve and still allows the machining tool 32 to be pulled into the bearing element without damaging the bearing element 38.

The front end of the contact element 36 has an opening 44, the cross-section of which is shaped to match the cross-sectional shape of the head of the friction-welded element 210. Moreover, the extent of the opening 44 is matched to the extent of the head of the friction-welded element 210 such that the extent of the opening 44 is only slightly greater than the extent of the head of the friction-welded element 210.

This makes it harder for the hand-held machine 10 to tilt relative to the head of the friction-welded element 210, facilitating the setting of an orientation that is orthogonal to the surface of the component assembly 200, particularly the top layer 220. The opening 44 may also be adapted along its axial extent to the contour of the head of the friction-welded element 210.

As a result, the distance of the bearing element 38 and to the front end of the contact element 36 can be small and still ensure a sufficient drilling depth.

In the present embodiment of the hand-held machine 10 according to the invention, a stop 50 is provided which limits the possible drilling depth. The stop 50 includes a contact element-side stop surface 52a and a machine housing-side stop surface 52b, which abut each other when the maximum drilling depth is reached. The stop 50 also has an adjusting element 54 by means of which the position of the stop surface 52a on the contact element side can be variably adjusted. This allows different component thicknesses to be taken into account.

The stop 50 also has an optical signal unit 55 that includes LEDs 54 which are circumferentially disposed on the attachment device. In addition, a stop pushbutton 56 is provided so that a corresponding signal can be output via the LEDs 54 when the stop has been reached. This can be displayed, for example, by the LEDs flashing. In addition to the mechanical stop, a visual signal is also displayed to the user that indicates when the maximum drilling depth has been reached. This is important especially because a user will not easily feel a reduction of the feed rate when the stop is reached. The reason for this is that, due to the hardness of the friction-welded element, the necessary feed force is relatively large and the feed rate when machining the friction-welded element is relatively low.

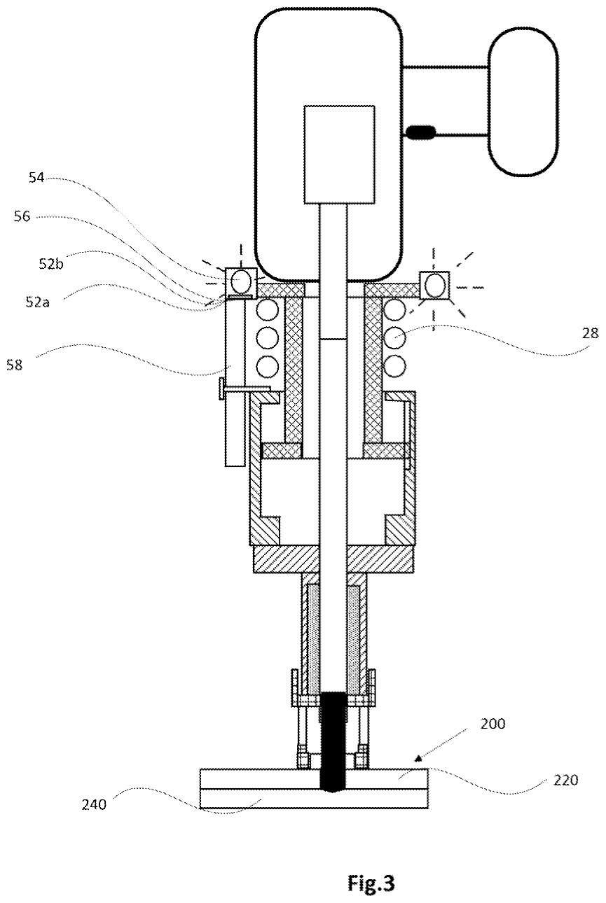

In addition, there may be a change in color after a certain stop duration, for example. This allows the amount of time to be reduced for which the machining tool 32 is at the maximum drilling depth. A working position, when the maximum drilling depth has been reached, is shown in FIG. 3.

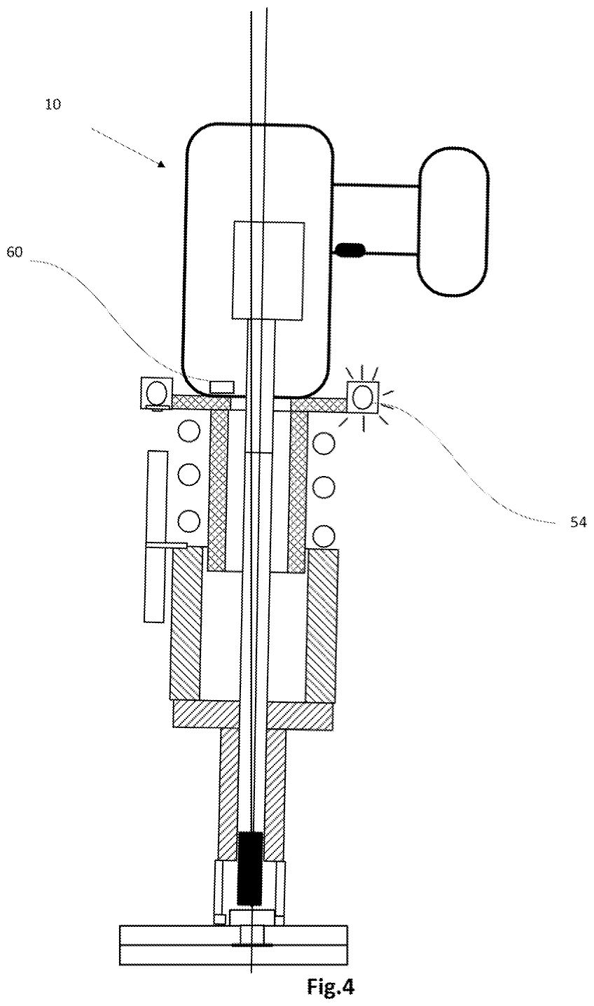

In addition, the attachment device 20 includes an alignment aid 60 that indicates a change in position of the hand-held machine from the working position. The function of the alignment aid is described in more detail in particular with reference to FIG. 4.

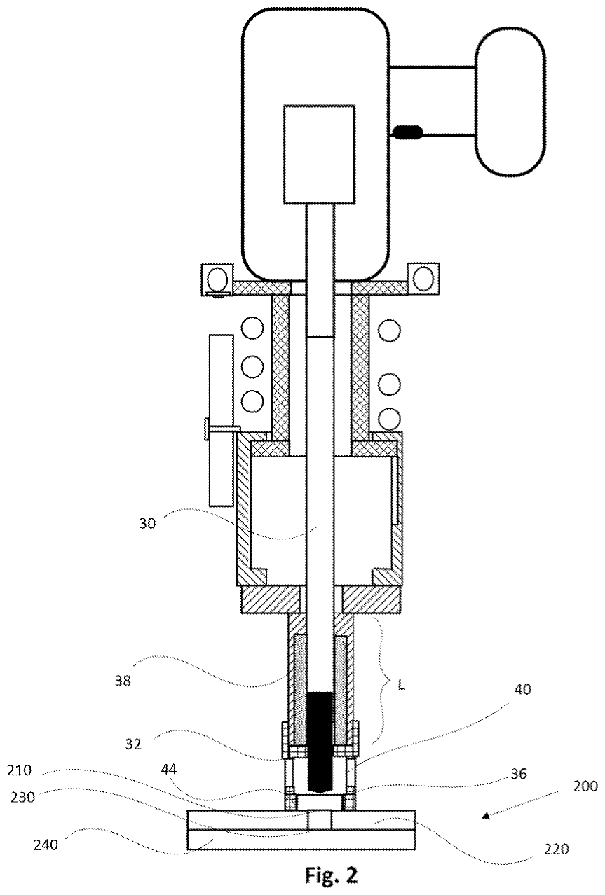

FIG. 2 shows a state in which the hand-held machine 10 with the contact element 36 is placed on the top layer 220 of the component assembly 100. In this case, the contact element 36 is guided close to the head. In the initial position, the front end of the machining tool 32 is just above the head, with the tool drive shaft 30 guided in the bearing element 38.

The close guidance of the contact element 36 on the head of the friction-welded element 210 supports an initial alignment of the hand-held machine 10 that is normal to the surface of the top layer 220. Preferably, an initialization of the alignment aid 60 can also be performed in this position.

The adjusting element 58 of the stop 50 is set to approximately the distance of the head height and the thickness of the top layer. This ensures that the base layer 240 will not be pierced completely during the drilling process. In this way, another friction-welded element can be placed on the machined area afterwards.

FIG. 3 shows a machining position in which the final drilling depth has been reached. In this position, the stop surfaces 52a, 52b rest against each other. The pushbutton 56 is pressed during this process which preferentially switches the LEDs 54 to flashing mode. The spring 28 is overpressed in this position.

In this position, the shank of the friction-welded element 210 is removed from the component joint and the head of the friction-welded element 210 is also no longer connected to the top layer 220 or the base layer 240. At this point, the machining process for removing the friction-welded element 210 has been completed and the rotary motion can be stopped. In this manner, a blind hole was made in the component assembly 200, with the bottom of the blind hole formed by the base layer 240. A friction-welded element 210 can then be bonded to the base layer 240 again, the head of which then again holds the top layer 220 in place in a form-fitting manner.

FIG. 4 illustrates the function of the alignment aid 60. In this embodiment, the alignment aid 60 includes position sensors or position change sensors, such as accelerometers, to determine if there is a deviation from the initialized working alignment.

The alignment aid 60 further includes LEDs 54 disposed circumferentially about the attachment device. In addition, the alignment aid has a control unit that activates a corresponding LED 54 as a function of the detected deviation from the initial working alignment. In this way, the user can see in which direction the compensation movement/inclination must be made so that the position of the working machine 10 corresponds again to the initialized working orientation.

Despite the small contact area of the contact element 36, this improves keeping the working direction normal to the component assembly 100. Thus, in this embodiment, the LEDs 54 may be part of the signal unit of the stop as well as display means of the alignment aid 60.

A differentiation of whether the LEDs 54 function as a stop display or as an alignment aid can be made, for example, by the type of display. Reaching the adjusted drilling depth can be indicated by all LEDs 54 flashing, for example, whereas a deviation from the working alignment can be indicated by continuous illumination of individual LEDs 54.

It is apparent to those skilled in the art that there are multiple ways in which the two states can be displayed in distinctive manner electro-optically.

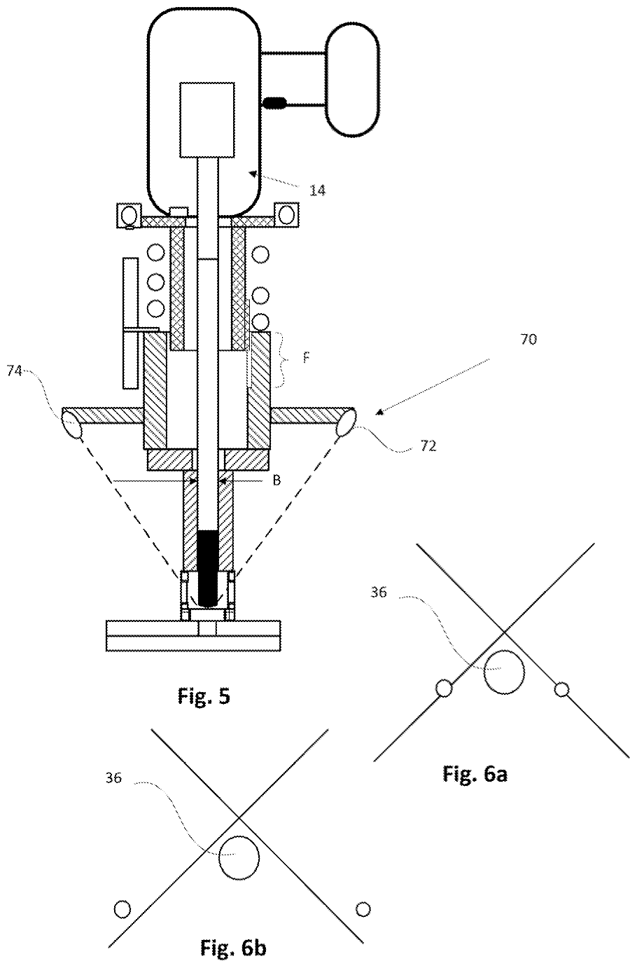

FIG. 5 is another embodiment of the hand-held machine 10 according to the invention, which corresponds essentially to the embodiment of FIG. 1, but differs from the embodiment of FIG. 1 in the design of the alignment aid 70, which is in the form of a laser alignment aid. For this purpose, the alignment aid 70 includes light sources that project a pattern onto the surface, which pattern can be used to identify the orientation of the hand-held machine in terms of inclination relative to the surface. The pattern preferably comprises two lines crossing at least in their extent, and two points that will lie on top of each other when the tool drive shaft axis is aligned orthogonally to the surface. In the embodiment of FIG. 5, the two lines are generated by a cross laser and the two points are generated by two point lasers 72. 74.

In this way, the projected pattern allows the user both to check whether the working orientation is normal to the surface and to verify that the working orientation is maintained during the drilling operation.

Alternatively, the crossed lines can also be generated with two correspondingly arranged line lasers.

The advantage of the arrangement on the second component is that the distance from the surface will not change during drilling and therefore the projection of the pattern will not be adversely affected.

FIG. 6a is a corresponding pattern when the rotational axis of the tool shaft is orthogonal to the top layer. FIG. 6b is a pattern created when the inclination of the rotational axis of the tool shaft deviates from being orthogonal to the top layer.

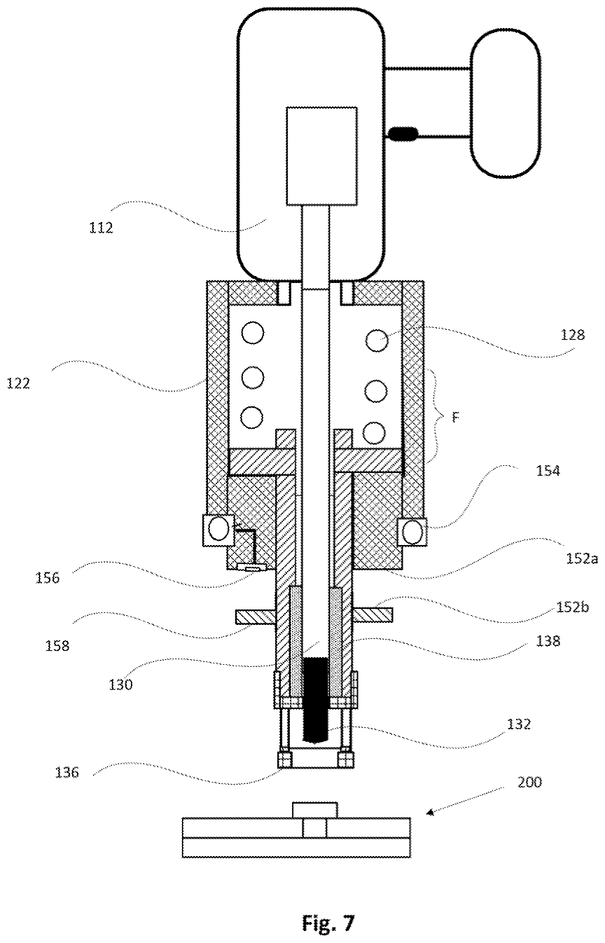

FIG. 7 is a schematic sectional view of another embodiment of a hand-held machine 110 according to the invention. The attachment device 120 includes a telescopic element 122 having a first component 124 and a second component 126 that are axially movable relative to one another against the prestress of a spring 128.

In this embodiment, the first component 124 is radially outside the second component 126. The telescopic element 122 has a guide area F along which the second component 126 is guided on the first component 124 so as to be non-rotatable and so that it can move in the axial direction. For example, in this region, the first component 124 may have a flattened portion on its inner surface at least in the guide region F, and the second component 126 may comprise a pressure piece 137 having a flange 127 formed thereon. The flange 127 may in turn have a flattened portion that corresponds to the flattened portion on the first component 124 to achieve anti-rotation lock of the second component 126 relative to the first component 124. Moreover, the flange 127 of the second component 126 serves as a pull-out limit and as a support for the spring 128.

Attached to the first component 124 is a signal unit that includes a plurality of LEDs 154 and a stop pushbutton 156 connected to the LEDs 154.

The first component 124 includes a connection portion for releasably connecting the attachment device 120 to the machine housing 112. Although the spring 128 is in direct contact with the first component 124, it thus prestresses the second component 126, after it has been fastened, with respect to the machine housing 112, so that the user presses directly against the spring force when placing the machine to advance it.

Accordingly, the pull-out limit and the length of the tool drive shaft 130 and the machining tool are coordinated so that, in the limiting position, the drill will not project beyond the contact surface, and is preferably spaced from the contact surface by even more than the head height.

The second component 126 includes a sliding bearing sleeve 136 that is secured to the pressure piece 127 in the forward end of the pressure piece 137 near the contact element 136, where it supports the tool drive shaft 130.

The pressure piece has a thread on its outside, in particular a fine-pitch thread, and an adjusting element 158 designed as an adjusting ring, which can be used to adjust the maximum drilling depth. When the maximum drilling depth has been reached, the stop surfaces 152a, 152b move towards one another. In this stop position, the pushbutton 156 is pressed and the LEDs 154 then signal that the stop position has been reached.

The contact element is preferably designed in the same way as described with reference to FIG. 1.

1-14. (canceled)

15. Hand-held machine (10, 10) for removing a friction-welded element, having a head, from a component assembly, wherein the hand-held machine (10, 10) comprises a machine housing (12) and a drive unit (14) which is received therein, wherein, furthermore, an attachment device (20, 120) is provided which is connected to the machine housing, wherein the attachment device comprises, furthermore, a telescopic element (22, 122) which has a first component (24, 24), arranged free from movement relative to the machine housing, and a second component (26), arranged movably in the axial direction relative to the first component, wherein the second component is prestressed in the axial direction in the pressing direction against the machine housing, furthermore, the attachment device has a tool drive shaft (30, 130) which is driven via the drive unit, wherein the tool drive shaft is mounted rotationally on the second component by a bearing element (38, 138) and is guided axially movably relative to the second component, wherein the second component has a contact element (36, 136), by way of which the second component can be placed onto the component assembly, wherein a machining tool (32, 132) is connected to the tool drive shaft, wherein. furthermore, a stop (50, 150), by which the drilling depth is limited, acts between the second component and the machine housing.

16. Hand-held machine according to claim 15, characterized in that the bearing element (38, 138) is a sliding bearing, in particular taking the form of a sliding bearing sleeve.

17. Hand-held machine according to claim 15, characterized in that the first component (24, 124) and the second component (26, 126) engage with one another in a guide region (F), with the bearing element (38, 138) being located between the front end of the contact element (36, 136) and the guide region (F).

18. Hand-held machine according to claim 15, characterized in that the bearing element (36, 136) is of a sleeve-shaped design and has lateral recesses (40) made therein for chip evacuation.

19. Hand-held machine according to claim 15, characterized in that the stop (50, 150) is adapted to be varied for adjusting the maximum drilling depth and comprises an adjusting element (58, 158).

20. Hand-held machine according to claim 15, characterized in that the stop (50, 150) interacts with a signal unit (54, 154).

21. Hand-held machine according to claim 15, characterized in that the attachment device (20, 120) includes an alignment aid (60, 70) that comprises a display device (54, 72, 74) for positional deviation.

22. Hand-held machine according to claim 20, characterized in that the alignment aid (60) comprises at least one accelerometer capable of measuring acceleration about at least two axes, and the display device for positional deviation comprises an electro-optical display (54).

23. Hand-held machine according to claim 15, characterized in that the alignment aid (70) comprises diodes (72, 74) capable of projecting a pattern onto a drilling surface.

24. Hand-held machine according to claim 20, characterized in that the signal unit is an electro-optical display (54), and in that the electro-optical display (54) and the alignment aid (60) use the same display means.

25. Hand-held machine according to claim 15, characterized in that the first component (24) is located radially inward and the second component (26) is located radially outward.

26. Method for repairing a friction-welded joint (200) comprising a friction-welded element (210) having a head and a shank, the head having a head diameter and the shank having a shank diameter, the friction-welded element (210) connecting a base layer (220) to at least one top layer (240), characterized in that the shank of the friction-welded element (210) is removed with a hand-held machine having a machining tool, by passing the rotating machining tool through the head of the friction-welded element (210) in the direction of the shank, and drilling a blind hole to a depth at which the weld zone (230) of the friction-welded element (210) with the base layer (240) is located, wherein the outside diameter of the machining tool is at least equal to the outside diameter of the shank of the friction-welded element (210), wherein, after completion of the drilling operation, a new friction-welded element (210) is inserted to form a friction-welded joint (230) with the bottom of the blind hole.

27. Method according to claim 26, characterized in that a hand-held machine (10) as claimed in any one of claims 1 to 11 above is used for removing a friction-welded element (210).

28. Method according to claim 27, characterized in that the cross-sectional shape of the opening (44) of the contact element (36) corresponds to the cross-sectional shape of the head of the friction-welded element (210), and the extent of the opening (44) is only slightly larger than the extent of the head of the friction-welded element (210).
